(19) United States
(12) Patent Application Publication
(10) Pub. No.: US 2002/0147796 A1
(43) Pub. Date: Oct. 10, 2002

(54) Method for saving a network address

(75) Inventor: Dae-Suk Chung, Austin, TX (US)

Correspondence Address: Frank C. Nicholas, CARDINAL LAW GROUP, 1603 Orrington Avenue, Suite 2000, Evanston, IL, 60201, US

(73) Assignee: International Business Machines Corporation, Armonk, NY

(21) Appl. No.: 09/826,702

(22) Filed: Apr. 5, 2001

(51) Int. Cl. G06F 15/177

(52) U.S. Cl. 709/220

(57) ABSTRACT

A method for saving a network address is provided. In the method, a network address is selected. A root address is acquired from the network address. The root address is then copied to a computer usable medium.

### FIELD OF THE INVENTION

The present invention generally relates to computer workstations, communication networks, computer networks, and the Internet. More specifically, the present invention relates to an improved technique for automatically saving a Uniform Resource Locator (URL) within a computer network and, in particular, within an operating system or network browser.

### BACKGROUND OF THE INVENTION

In the environment of network computers and communications, the Uniform Resource Locator (URL) has become ubiquitous to a means of pointing to or identifying a network address location (also referred to as network location, page address, and web page address) of a specific item or data site accessible in a computer network, the network often called a Web, WAN, or LAN. A URL typically points to a Hypertext Markup Language (HTML) encoded data item, such as a page of information that can be downloaded from the web and displayed at a user's workstation, stand alone, or network computer. However, a URL might easily point to a text file or a spreadsheet of data, another application program, a library, a file, or a database. In fact, any of the elements that a personal computer user normally accesses from their desktop environment can be made available over a computer network using the network operating system (OS) or network browser (browser).

Modern operating systems are not only capable of accessing text, files, folders, and applications, but can also access network address' of text, files, folders, and applications. A more specialized application for accessing network content is the browser. Browsers typically reside on a user's workstation (PC) and can be invoked when the user decides to access communications networks, such as the Internet or Web. A prior art browser program typically sends and receives URL requests and responses to and from the communications network, which forms the web. The browser also processes each type of data that is presented to it, and forwards and receives data to and from the web. One type of data processed is HTML, and can be displayed by the browser using an embedded rendering function.

As a conventional browser is moved from URL to another URL, or a hyperlink is selected from a displayed URL content such as an HTML page, the browser will access a new URL indicated by the hyperlink or the user's new selection. When this occurs, the previously active URL may be made inactive and stored in a history list or it may be deleted entirely. A potential problem occurs if the URL is deleted entirely and a user (operator, client) of the browser wishes to return to a previously viewed URL.

A more distinct problem may occur even if the URL is saved to a history list. Typically automatic in its operation, a history list only saves the previous URL in its totality. The saved URL may include a number of URLs embedded to form a single URL arrangement. The exact number and arrangement of embedded URLs is determined by the original author of the HTML page of data and does not affect the user's operating system or environment in a way which would allow arbitrary activation of any root URLs by the user. This becomes a problem if the user wishes to visit the homepage of a previously visited URL and not its saved page network address. The same problem may occur when a URL is manually saved to an alternate location such as a bookmark folder, or a favorites list.

In addition, most prior art browsers maintain a history list of URLs that have been accessed and made active over some period. Depending upon the browser application itself, the history list may keep a record of URLs that have been previously active over one or many sessions, or only over a short period such as since logon. It should be obvious that as time passes and the history list grows, it will become increasingly difficult for the user to locate a root page address (URL) when the root page may be accompanied by numerous child pages associated with the root page.

Therefore, it would be desirable to have a method for saving only URL address of the parent or root. Further, it would be desirable that the method provide for and overcome the complexities and problems as mentioned above, thus improving upon the existing art.

### SUMMARY OF THE INVENTION

The present invention provides a method for saving a network address. In one aspect of the invention, a network address is selected, a root address is acquired from the network address and the root address is then copied to a computer usable medium.

Another aspect of the invention provides a system for saving a network address including a means for selecting a network address, a means for acquiring a root address from the network address, and a means for copying the root address to a computer usable medium.

Another aspect of the invention provides a computer-usable medium storing a computer program that contains computer-readable program code for selecting a network address. The computer-readable program code next acquires a root address from the network address and copies the root address to the computer usable medium.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is an illustration of a one embodiment of a network browser, in accordance with the present invention;

FIG. 2 is an illustration of a bookmark editing feature provided to the network browser of FIG. 1;

FIG. 3 is an illustration of an autosave feature provided to the network browser of FIG. 1;

FIG. 4 is a flow chart representation of a method for providing the autosave feature of FIG. 3, in accordance with the present invention; and

FIG. 5 is an illustration of one embodiment of an information handling system capable of performing the method of FIG. 4, in accordance with the present invention.

### DETAILED DESCRIPTION OF A PREFERRED EMBODIMENT

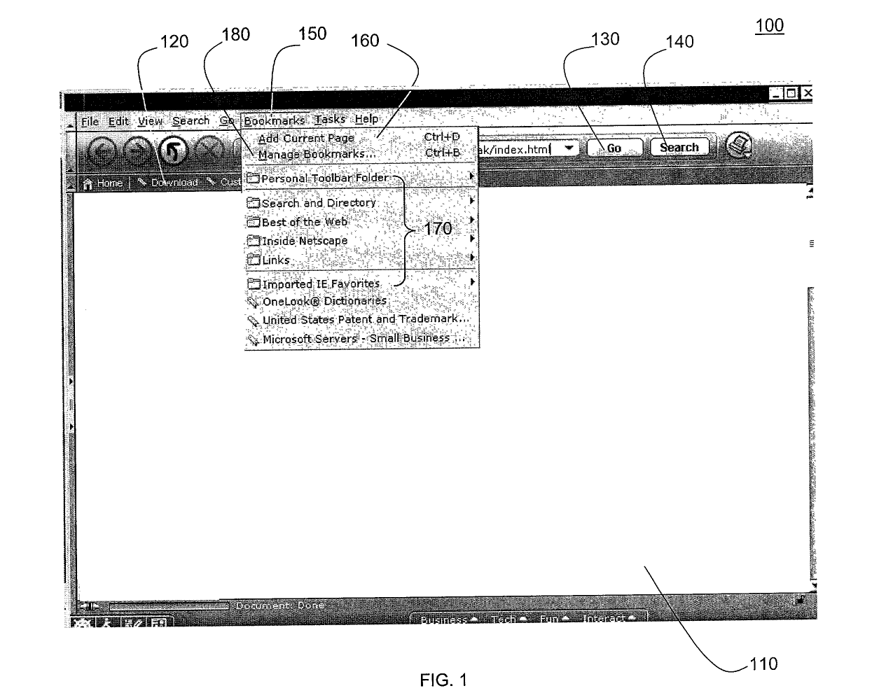

FIG. 1 illustrates a network browser 100 used by one embodiment of the invention. The browser 100 can be a program used to view, download 120, upload 130, surf 140 or otherwise access documents 110 (pages) on the World Wide Web or alternative network. The browser 100 can be text-based, meaning it does not show graphics or images, but may be text and graphic based. The browser 100 shall refer to any method or system capable of accessing or displaying a URL, and include operating systems, network management systems, and network browsers.

A browser 100 can read “marked up” or coded pages and can interpret the coding into a web page 110 rendition, illustration, or graphic. The coding can be HTML and can reside on network servers, but other codes can be used. In addition, browser 100 can present multimedia information, including sound and video, though it may in one embodiment, require a plug-in for increased functionality.

Plug-ins may be hardware or software modules that add a specific feature or service to the browser 100. For example, there may be a number of plug-ins for the browser 100 that enable it to display the different types of audio or video messages of the current web page 110. An embodiment of the invention may be embedded in part or whole in a plug-in, or the invention may be provided as the plug-in. This embodiment helps a user have URLs saved in a bookmark list or separate folder. An additional embodiment of the invention provides a saving feature that can copy and save a URL automatically. Further, the automatic save feature may be turned on or off by an automatic save setting within the browser 100, operating system, or it may be provided within the inventions own interface. Another embodiment of the invention may provide saving of URL's to be performed in such a way that only the main (parent or root) address of the visited URL is saved. The invention may further provide for a user to manually store and edit saved URL's. The invention can allow users to view the root sites of URL's previously found of interest, selecting only those that the user wants to save permanently into folders, and deleting or editing root address's to others.

The browser 100 can include a bookmark feature 150. The bookmark feature 150 may be identified as favorites, favorite sites, links, or alternate term as is known in the art. The bookmark feature 150 may add 160 or bookmark favorite sites so that the sites can be found again quickly and easily. In addition, bookmark features 150 may include general folders 170 to sort and store bookmarked sites, and editing functions 180 for manipulating the stored bookmarks 150.

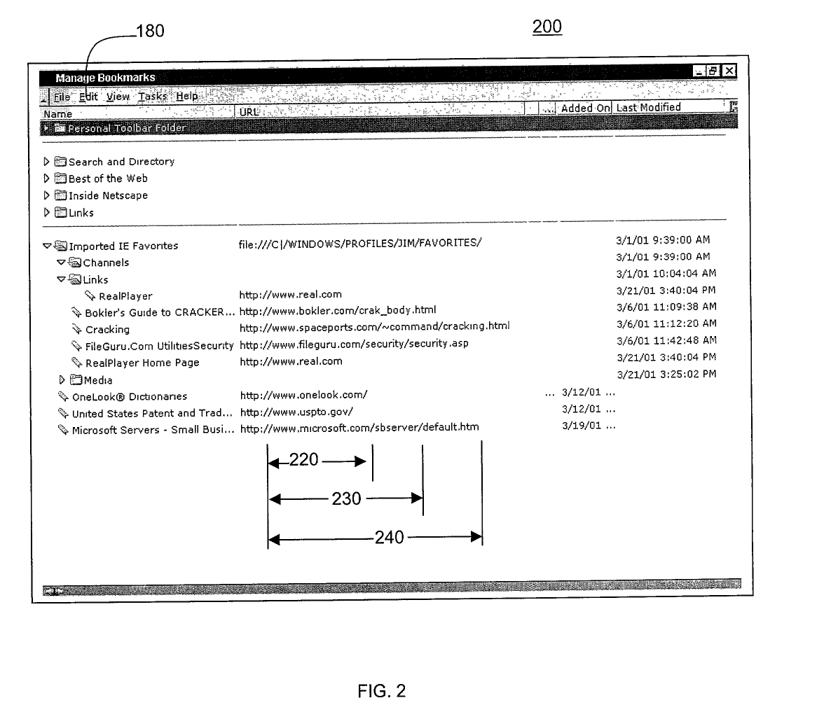

FIG. 2 is an illustration of a bookmark manager 200 that provides the editing functions 180 for one embodiment of the browser 100. Further illustrated is an example URL address www.microsoft.com/sbserver/default.htm 240. The URL www.microsoft.com/sbserver 230 is the parent of URL 240, and URL www.microsoft.com 220 is the parent of URL 230. URL 220 is also the root address for URL 230, and 240. One embodiment of the invention can remove all child address's and save only the root address for any preferred URL. Another embodiment provides that the invention operate as a part of the bookmark manager 200 or any like URL storing and editing system. In addition, an embodiment of the invention may operate alone or in combination with any URL storing and editing system, browser, or operating system.

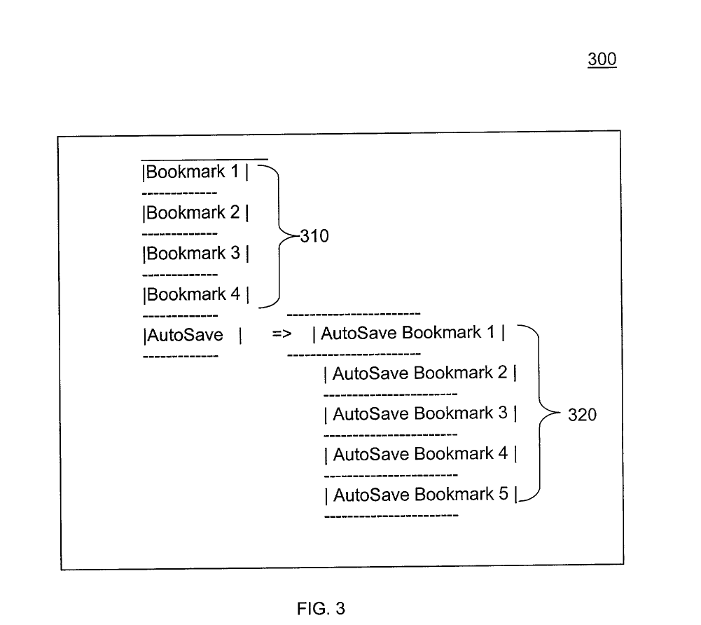

FIG. 3 is an illustration of an embodiment of an autosave feature. The autosave feature 300 can save any newly visited web page 310, first as a temporary bookmark, and then move the temporary bookmark to a predefined (autosave) folder 320. In one embodiment, once the automatic save function has been set to on, the root URL name can be bookmarked automatically in the autosave folder. The user can then browse through the pages at any future time and decide whether to keep a page. In one embodiment, this can be done with Save, Add, and Edit features that current browsers provide. A further example of the save routine states that if the visited page URL was http://www.usstates.com/pictures/texas/index.html, only http://www.usstates.com/ may be saved by this embodiment.

An additional embodiment allows for the saving of root URL's to be performed only once, no matter how many sub-pages have been visited. Over a period and if the save feature has been set to on, the number of saved URL entries may grow substantially. For this embodiment of the invention, the user may specify the maximum number of days a page not revisited should be kept in the autosave folder 320, deleting any outdated address's.

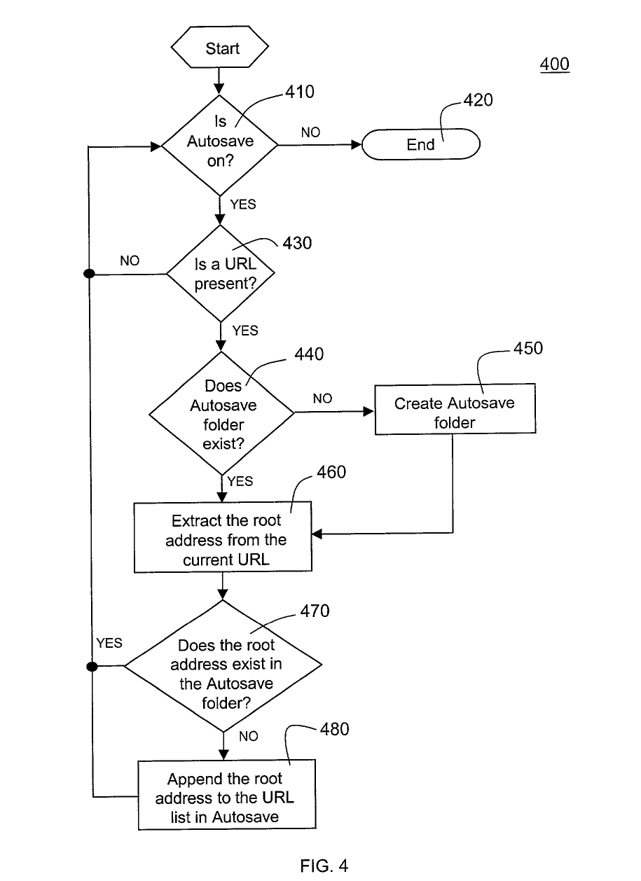

FIG. 4 illustrates a flowchart diagram for a method 400 of an embodiment of the present invention. The charted logic for this embodiment of the invention begins by determining if the save (autosave) feature is activated 410. If the autosave feature is not active, nothing may be performed by this embodiment and it turns off (end) 420. If the autosave feature is on, an embodiment queries a browser or operating system to determine if a URL is present 430. If not, the embodiment may return to check again if the autosave function is active 410. If a URL is acquired, one embodiment of the invention may then check that a predefined folder (autosave folder) exists 440. If not, the folder may be created 450. Next, the root address may be extracted from the address of the current URL 460. Once extracted, the root address may be compared with the currently saved root address' within the autosave folder 470. Any duplicate root address's can be discarded and the method 400 may return to its initial state of checking that autosave is on 410. If the newly created root address is not in the autosave folder, one embodiment appends the root address to the save URL list 480. The method then returns to the state of checking if the autosave is on 410.

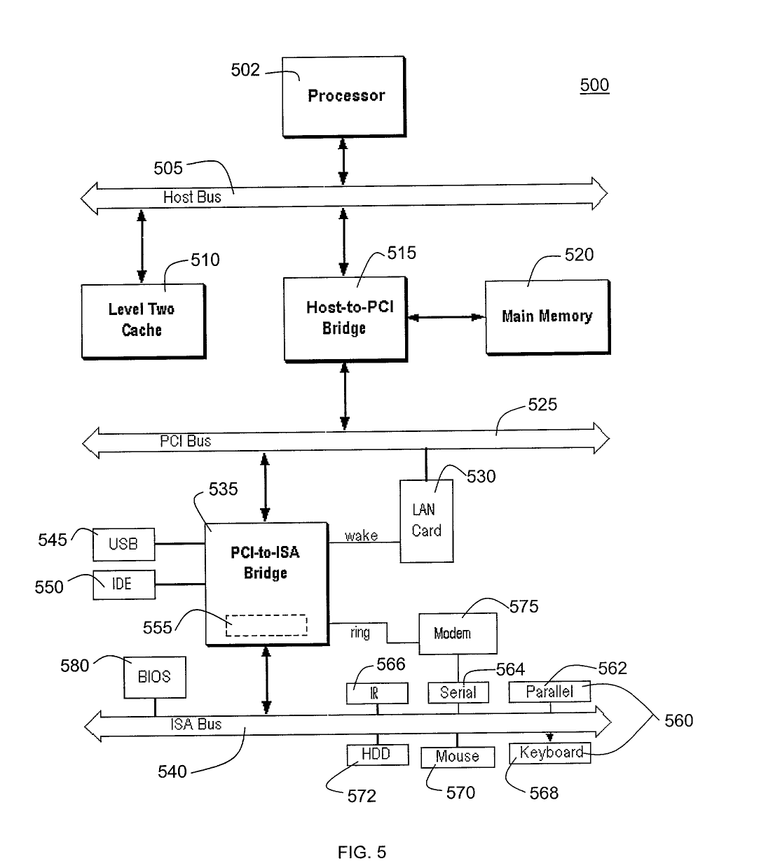

FIG. 5 illustrates an information handling system 500 (computer system) capable of performing the embodiments of the invention as previously described. Computer system 500 includes processor 502, which may be coupled to host bus 505. A level two (L2) cache memory 510 may also be coupled to the host bus 505. Host-to-PCl bridge 515 may be coupled to main memory 520, and may include cache memory and main memory control functions. Host-to-PCl bridge 515 may as well provide bus control to handle transfers among PCl bus 525, processor 502, L2 cache 510, main memory 520, and host bus 505. PCl bus 525 can provide an interface for a variety of devices including, for example, LAN card 530. PCl-to-ISA bridge 535 can provide bus control to handle transfers between PCl bus 525 and ISA bus 540, universal serial bus (USB) functionality 545, IDE device functionality 550, power management functionality 555, and can also include other functional elements not shown, such as a real-time clock (RTC), DMA control, interrupt support, and system management bus support. Peripheral devices and input/output (I/O) devices can be attached to various interfaces 560 (e.g., parallel interface 562, serial interface 564, infrared (IR) interface 566, keyboard interface 568, mouse interface 570, and fixed disk (FDD) 572) coupled to ISA bus 540. Alternatively, many I/O devices may be accommodated by a super 1/0 controller (not shown) attached to ISA bus 540.

BIOS 580 can be coupled to ISA bus 540, and incorporate the necessary processor executable code for a variety of low-level system functions and system boot functions. BIOS 580 can be stored in any computer readable medium, including magnetic storage media, optical storage media, flash memory, random access memory, read only memory, and communications media conveying signals encoding the instructions (e.g., signals from a network). In order to attach computer system 500 to another computer system (network), LAN card 530 can be coupled to PCl-to-ISA bridge 535. Similarly, to connect computer system 500 to an ISP, to connect to the Internet using a telephone line connection, modem 575 can be connected to serial port 564 and PCl-to-ISA bridge 535.

While the computer system described in FIG. 5 may be capable of executing the embodiments of the invention as described herein, this computer system is simply one example of a computer system. Those skilled in the art will appreciate that many other computer system designs are also capable of performing as described herein.

One of the preferred embodiments of the invention may contain an application or set of instructions (program code) in a code module that may, for example, be resident in the random access memory of the computer. Until required by the computer, the set of instructions may be stored in another computer memory, for example, in a hard disk drive, or in a removable memory such as an optical disk (for eventual use in a CD ROM), or downloaded via the Internet or other computer network. Thus, the present invention may be implemented as a computer program product for use in a computer and, furthermore, the computer medium that may embody the invention can include a transmission means. In addition, although the various methods described can be implemented in a general-purpose computer, one of ordinary skill in the art would also recognize that such methods may be carried out in hardware, in firmware, or in more specialized apparatus constructed to perform the required method steps.

The above mentioned actions and like procedures may be created using JAVA, C, C++, HTML, LISP, or other programming languages known in the art. The present invention may be embodied in other specific forms without departing from its spirit or essential characteristics. The described embodiments are to be considered in all respects only as illustrative and not restrictive.

WE claim:

1. A method for saving a network address comprising:
selecting a network address;
acquiring a root address from the network address; and
copying the root address to a computer usable medium.

2. The method of claim 1 wherein selecting the network address, acquiring the root address from the network address, and copying the root address to the computer usable medium are performed without user intervention.

3. The method of claim 1 further comprising viewing the network address using a network browser.

4. The method of claim 1 further comprising placing the copied root address into a bookmark folder.

5. The method of claim 4 further comprising placing the copied root address into a subfolder within the bookmark folder.

6. The method of claim 1 further comprising checking for the existence of an autosave folder on the computer usable medium.

7. The method of claim 6 further comprising creating the autosave folder to the computer usable medium.

8. The method of claim 7 further comprising placing the copied root address into the autosave folder.

9. The method of claim 1 further comprising manipulating attributes associated to the copied root address.

10. The method of claim 1 further comprising checking for a new network address connection.

11. The method of claim 1 further comprising appending the copied network address to a network address list.

12. The method of claim 11 further comprising providing connectivity between the network address list and a network browser.

13. A system for saving a network address comprising:
means for selecting a network address;
means for acquiring a root address from the network address; and
means for copying the root address to a computer usable medium.

14. The system of claim 13 further comprising means for automating the selecting the network address, acquiring the root address from the network address, and copying the root address to the computer usable medium actions.

15. The system of claim 13 further comprising means for checking for the existence of an autosave folder on the computer usable medium.

16. The system of claim 15 further comprising means for creating the autosave folder to the computer usable medium.

17. The system of claim 13 further comprising means for manipulating attributes associated to the copied root address.

18. The system of claim 13 further comprising means for checking for a new network address connection.

19. A computer-usable medium storing a computer program, comprising:
computer-readable program code for selecting a network address;
computer-readable program code for acquiring a root address from the network address; and
computer-readable program code for copying the root address to the computer usable medium.

20. The computer-usable medium of claim 19 further comprising computer-readable program code for automating the selecting the network address, acquiring the root address from the network address, and copying the root address to the computer usable medium actions.
